(19) United States
(12) Patent Application Publication
(10) Pub. No.: US 2025/0092533 A1
(43) Pub. Date: Mar. 20, 2025

(54) DEVICE AND METHOD FOR PREPARING ALIGNED CARBON NANOTUBE FIBERS THROUGH ELECTROCHEMICAL STRETCHING

(71) Applicant: SUZHOU INSTITUTE OF NANO-TECH AND NANO-BIONICS (SINANO) , CHINESE ACADEMY OF SCIENCES, Suzhou (CN)

(72) Inventors: Jiangtao DI, Suzhou (CN); Yulian WANG, Suzhou (CN); Yueran ZHAO, Suzhou (CN); Qingwen LI, Suzhou (CN)

(73) Assignee: SUZHOU INSTITUTE OF NANO-TECH AND NANO-BIONICS (SINANO) , CHINESE ACADEMY OF SCIENCES, Suzhou (CN)

(21) Appl. No.: 18/291,585

(22) PCT Filed: Apr. 29, 2022
(86) PCT No.: PCT/CN2022/090335

§ 371 Date: Jan. 24, 2024

(30) Foreign Application Priority Data
Feb. 17, 2022 (CN) 202210146466.7

(51) Int. Cl. C25B 1/135; C25B 11/043; C25B 11/046; C25B 15/02

(52) U.S. Cl. CPC C25B 1/135; C25B 11/043; C25B 11/046; C25B 15/02

(57) ABSTRACT

A device and method for preparing an aligned carbon nanotube (CNT) fiber through electrochemical stretching. The method comprises: constructing an electrochemical reaction system by using an original CNT fiber as a working electrode stretching, a counter electrode, a reference electrode, and an electrolyte, applying a selected stretch stress to the original CNT fiber for electrochemical stretching while powering on the electrochemical reaction system so that ions in the electrolyte are embedded into the original CNT fiber, and the orientation of the carbon nanotube is generated due to the action of the stretch stress under the state of expansion; and powering off the electrochemical reaction system while maintaining the application of the selected stretch stress, so that the ions in the electrolyte are released, thereby obtaining a highly aligned CNT fiber.

### CROSS-REFERENCE TO RELATED APPLICATION

The present application is the national stage entry of International Application No. PCT/CN2022/090335 filed on Apr. 29, 2022, which is based upon and claims foreign priority to Chinese patent application No.202210146466.7, filed on Feb. 17, 2022, the entire contents of which are incorporated herein by reference.

### TECHNICAL FIELD

The present application relates to a method for preparing an aligned carbon nanotube (CNT) fiber through electrochemical stretching, particularly to a device and method for preparing an aligned carbon nanotube fiber through electrochemical stretching, belonging to the technical field of CNT fiber preparation.

### BACKGROUND

A carbon nanotube fiber is composed of millions of CNTs arranged and assembled in a nearly parallel manner. It has many excellent characteristics of lightweight, high strength, high conductivity, high thermal conductivity, structural flexibility, and surface modifiability. It is one of the best materials for developing intelligent artificial muscle fibers and is expected to produce intelligent actuation products with market values. The preparation methods of CNT fibers mainly include wet spinning from CNT solutions and dry spinning from spinnable CNT arrays or from CNT aerogels that grow by floating catalytic chemical vapor deposition.

Where, CNTs in a spinning array grow upward vertically to a substrate, and they are closely arranged with each other by Van der Waals force. Carbon nanotube fibers can be obtained by drawing a thin and aligned CNT sheet from the CNT spinnable array and twisting.

The preparation of CNT fibers by using the floating catalyst chemical vapor deposition method is that a CNT aerogel network is formed by utilizing pyrolysis deposition of a carbon source gas, and the CNT network is densified to form CNT fibers. Continuous CNT fibers can be continuously grown by using the floating catalyst chemical vapor deposition.

The alignment of CNTs in the fibers has a key impact on the strength and conductivity of the fibers. The CNT fibers with good nanotube alignment have good inter-tube contact, high mechanical strength, and increased conductivity.

At present, the industry's main method for macroscopic orientation of carbon nanotube fibers is to use a mechanical method for step-by-step stretch. During the mechanical stretching, oriented carbon nanotubes are likely to slip between tubes, thereby leading to a great increase in their strength. However, this method has problems such as poor stretch uniformity, low stretch rate, and unclear increase in orientation, thereby resulting in unstable mechanical properties of the fibers.

Therefore, as far as the current technology is concerned, the internal orientation of the floating catalytic fibers is difficult to improve.

### SUMMARY

The main object of the present application is to provide an electrochemical stretching method for preparing an aligned CNT fiber to overcome the problems of poor stretch uniformity, low stretch rate, and unapparent orientation increase that exist in the prior art.

To achieve the above-mentioned objective, the technical solution adopted by the present application includes the following aspects.

The embodiment of the present application provides a method for preparing an aligned CNT fiber through electrochemical stretching, which comprises the following steps.

Constructing an electrochemical reaction system by at least using an original CNT fiber as a working electrode, a counter electrode, a reference electrode, and an electrolyte, wherein the electrolyte is an organic system. Cations contained in the electrolyte are derived from a tetraethyl salt, a tetrabutyl salt, or a tetrahexyl salt, and anions contained in the electrolyte are derived from salts comprising at least one of tetrafluoroborate, hexafluorophosphate and/or ionic liquids;

Applying selected stretch stress to the original CNT fiber and powering on the electrochemical reaction system. Ions in the electrolyte are thus inserted into the original CNT fiber, and the orientation of the CNTs is generated due to the action of the stretch stress under the state of expansion.

Powering off the electrochemical reaction system while maintaining the application of the selected stretch stress, so that the ions in the electrolyte are released, thereby obtaining a highly aligned carbon nanotube fiber.

The embodiment of the present application further provides a highly aligned CNT fiber prepared as described above.

The embodiment of the present application further provides a device for preparing an aligned CNT fiber through electrochemical stretching, which is applied to the above-mentioned method, and comprises:
an electrochemical reaction system at least comprising an original CNT fiber as a working electrode, a counter electrode, and an electrolyte; and
applying selected stretch stress to the original CNT fiber.

Compared with the prior art, the present application has the advantageous effects:
1) The method for preparing an aligned CNT fiber through electrochemical stretching provided in the present application can control fiber orientation degree, and the stretch ratio can be adjusted by the applied stress and applied voltage. Operation is carried out by a one-step method, and the method is convenient and fast and takes less than 10 minutes with the shortest time of 10 seconds.
2) The device for preparing an aligned CNT fiber through electrochemical stretching provided in the present application is simple in structure, easy to build, and wide in application range.
3) Compared with mechanical stretching, the stretch ratio is higher, and the structure after stretch is more uniform.

### BRIEF DESCRIPTION OF THE DRAWINGS

To provide a clearer explanation of the embodiments or technical solutions in the present application, a brief introduction will be given to the accompanying drawings required in the embodiments or description of the prior art the accompanying drawings in the following description are only some of the embodiments recorded in the present application, and other accompanying drawings can be obtained by ordinary persons of skill in the art based on these drawings without any creative effort.

FIG. 1 is a structural diagram of a device for preparing a CNT fiber through electrochemical stretching in a typical embodiment of the present application;

FIG. 2 is a mechanism diagram showing electrochemical orientation in a method for preparing a CNT fiber through electrochemical stretching in a typical embodiment of the present application;

FIG. 3 is a result diagram showing changes in stretch ratios at different voltages in example 1 of the present application;

FIG. 4 is a result diagram showing changes in orientation degrees at different voltages in example 1 of the present application;

FIG. 5 is a result diagram showing a comparison between conductivity and resistivity after 2.5 V stretch and conductivity and resistivity of the original fiber in example 1 of the present application;

FIG. 6A and FIG. 6B are a result diagram showing a comparison between capacitance after 2.5 V stretch and capacitance of the original fiber in example 1 of the present application;

FIG. 7 is a result diagram showing changes in stretch ratios under different stretching forces in example 2 of the present application;

FIG. 8 is a result diagram showing changes in stretch ratios under different frequencies in example 3 of the present application;

FIG. 9 is a result diagram showing changes in stretch ratios under different electrolyte concentrations in example 4 of the present application;

FIG. 10 is a result diagram showing changes in stretch ratios at different voltages in example 5 of the present application (untwisted fibers);

FIG. 11 is a result diagram showing changes in stretch ratios at different voltages in example 6 of the present application (twisted fibers);

FIG. 12 is a mechanical performance test result diagram after stretching at different voltages in example 6 of the present application (twisted fibers);

FIG. 13 is a result diagram showing changes in stretch ratios at different frequencies in example 7 of the present application (twisted fibers);

FIG. 14 is a stretch comparison diagram of electrolytes with different cations and identical anions in example 8 of the present application; and

FIG. 15 is a stretch comparison diagram of electrolytes with different cations and identical anions in example 9 of the present application.

### DETAILED DESCRIPTION OF THE EMBODIMENTS

Given the existing research foundation's problems such as poor stretch uniformity and low stretch rate with unclear increase in orientation, the inventor of this case has been able to propose the technical solution of the present application through long-term research and extensive practices. The main purpose is to independently design an electrochemical stretching device, which uses the electrochemical stretching method to prepare a CNT fiber with excellent orientation in one step. The method is convenient and fast. The following will provide further explanations and explanations on the technical solution, its implementation process, and principles.

A method for preparing an aligned CNT fiber through electrochemical stretching provided by one aspect of the embodiment of the present application comprises:
constructing an electrochemical reaction system by at least using an original CNT fiber as a working electrode, a counter electrode, a reference electrode, and an electrolyte, wherein the electrolyte is an organic system, cations contained in the electrolyte are derived from a tetraethyl salt, a tetrabutyl salt, or a tetrahexyl salt, and anions contained in the electrolyte are derived from salts comprising at least one of tetrafluoroborate and hexafluorophosphate, and/or ionic liquids;
applying a selected stretch stress to the original CNT fiber while powering on the electrochemical reaction system so that ions in the electrolyte are inserted into the original CNT fiber to generate the orientation of the carbon nanotube due to the action of the stretch stress under the state of expansion; and
powering off the electrochemical reaction system while maintaining the application of the selected stretch stress, so that the ions in the electrolyte are released, thereby obtaining a highly aligned CNT fiber.

In some embodiments, the electrolyte is an organic system and also contains organic solvents, the contained cations are all tetraethyl, tetrabutyl and tetrahexyl salts, and the anion is any one or a combination of more of all tetrafluoroborate and hexafluorophosphate salts and all ionic liquids.

The organic solvent can be propylene carbonate, correspondingly, the electrolyte can preferably include 1-ethyl-3-methylimidazole tetrafluoroborate/propylene carbonate, but is not limited thereto.

Further, the combination of the electrolytes can be a combination of any one modes and any concentrations of one or more of the above-mentioned electrolytes.

In some embodiments, the concentration of the electrolyte in the electrolyte needs to be 0.01 mol/L or more, but is not limited to these concentrations, and can be any mole concentration, for example preferably 0.1-1 mol/L.

In some embodiments, the selected stretch stress applied to the original CNT fiber needs to be 1 MPa or more (which is normalized to the crosssection of the fiber and can not exceed the strength of the fiber), preferably 1-9 MPa, and a stress should be applied to the original CNT fiber during the charging and discharging.

In some embodiments, a voltage applied to the original CNT fiber is 0-10V, and the frequency of the applied voltage is 0.01-2 Hz. In other words, the high voltage is below the decomposition voltage of the electrolyte: 0-10 V, and the low voltage is −1 V and remains fixed.

In some embodiments, the stretch ratio, which is obtained by normalizing the stretched length to the initial length of the fiber when immersed in the electrolyte, is 10%-200% by the electrochemical stretching.

In the present application, the sizes of the applied stretch stress and the applied voltage, the applying frequency of the voltage, and the concentrations of the electrolytes all have certain effects on the stretch ratio of the electrochemical stretching. The experiment proves that the higher the stretch ratio, the better the internal alignment of the CNT fiber.

In some more preferred embodiments, the method for preparing the oriented CNT fiber through electrochemical stretching specifically comprises the following processes:

With the electrochemical stretching device designed by the inventor of this case (as shown in FIG. 1), the working electrode is a CNT fiber, and the internal alignment of the original CNT fiber is disorderly and poor. When charging, a large number of solvated ions are embedded in the CNT fiber to lead to volume expansion of the CNT fiber. Under this state, due to the externally loaded stretching force, stretching is formed under the stretch stress, and the carbon nanotubes are rearranged. Then, when discharging, ions are released, thereby forming the highly stacked CNT fiber with excellent alignment.

In some embodiments, the original CNT fiber is a CNT fiber with poor alignment.

Further, the original CNT fiber includes at least any one of an untwisted CNT fiber, a twisted CNT fiber, an excessively twisted helical CNT fiber (such as a CNT fiber with a uniform helical structure), but is not limited thereto.

In some embodiments, the electrochemical reaction system also includes a reference electrode matched with a working electrode and a counter electrode, wherein the reference electrode can be an Ag/Ag electrode, but is not limited thereto. The reference electrode is used to confirm the potential of the working electrode. For most cases, the reference electrode is necessary for electrochemical stretching.

Further, the counter electrode can be a platinum black electrode but is not limited thereto.

Another aspect of the embodiment of the present application provides a highly aligned CNT fiber prepared by the aforementioned method.

Correspondingly, another aspect of the embodiment of the present application also provides a device for preparing an aligned CNT fiber through electrochemical stretching, which is applied to the aforementioned method, and comprises:
an electrochemical reaction system at least comprising an original CNT fiber as a working electrode, a counter electrode, a reference electrode, and an electrolyte; and
an electrochemical stretching mechanism at least used for applying selected stretch stress to the original CNT fiber for electrical stretching treatment.

In some specific embodiments, the structural diagram of the device for preparing an oriented CNT fiber through electrochemical stretching provided in the present application is shown in FIG. 1. The device consists of six parts, including an electrolyte 1, a working electrode (CNT fiber) 2, a counter electrode 3, a reference electrode 4, a fixed pulley 5, and a load stress mechanism 6.

In some more specific embodiments, the device for preparing the oriented CNT fiber by electrochemical stretching comprises a stretching system for an artificial muscle fiber assembled by using an electrochemical stretching device, a three-electrode system is used, the working electrode is a CNT fiber, the counter electrode is a platinum black electrode, the reference electrode is an Ag/Ag electrode, and the electrolyte is 1-ethyl-3-methylimidazole tetrafluoroborate/propylene carbonate dissolved into propylene carbonate.

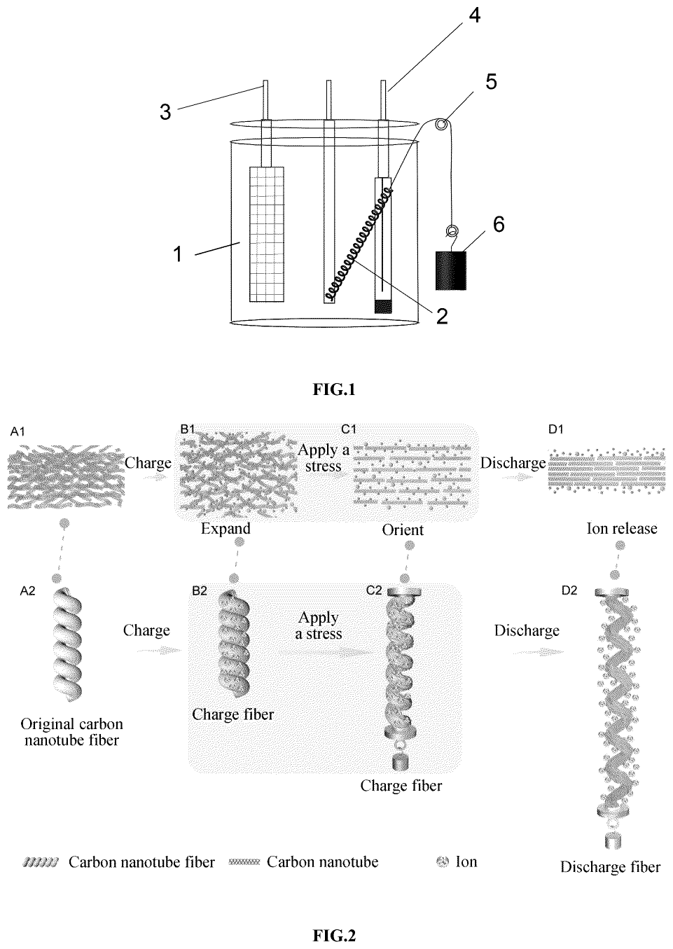

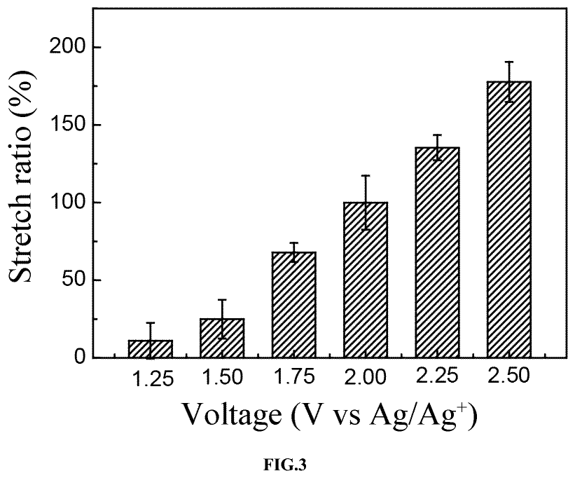

Referring to FIG. 2, the process and mechanism of electrochemically stretching the oriented CNT fiber by using the device for preparing the oriented CNT fiber through electrochemical stretching adopted by the present application are as follows: the CNT fiber is connected to the device as a working electrode when a voltage is applied, electrolyte are embedded into the CNT fiber so that the volume of the CNT fiber expands, then under the state of expansion, the alignment of the carbon nanotube occurs due to the effect of a stretching force, when powered off, ions are released, to obtain the highly aligned CNT fiber. This process is referred to as electrochemical stretching. The stretch ratio is calculated through a non-contact displacement sensor. The sizes of applied stretching stress and applied voltage, the applying frequency of the voltage, and the concentration of the electrolyte all have certain effects on the stretch ratio of electrochemical stretching. It has been proved by repeated experiments by the inventor of this case that the higher the stretch ratio, the better the internal orientation of the CNT fiber.

Next, the technical solution of the present application will be further illustrated in detail in combination with several preferred embodiments and drawings, obviously, the described embodiments are only some embodiments of the present application rather than all the embodiments. Based on the embodiments of the present application, all other embodiments obtained by persons of ordinary skill in the art without creative efforts fall within the scope of protection of the present application. The experimental methods without specific conditions specified in the following embodiments are usually based on conventional conditions or conditions recommended by manufacturers.

### Example 1

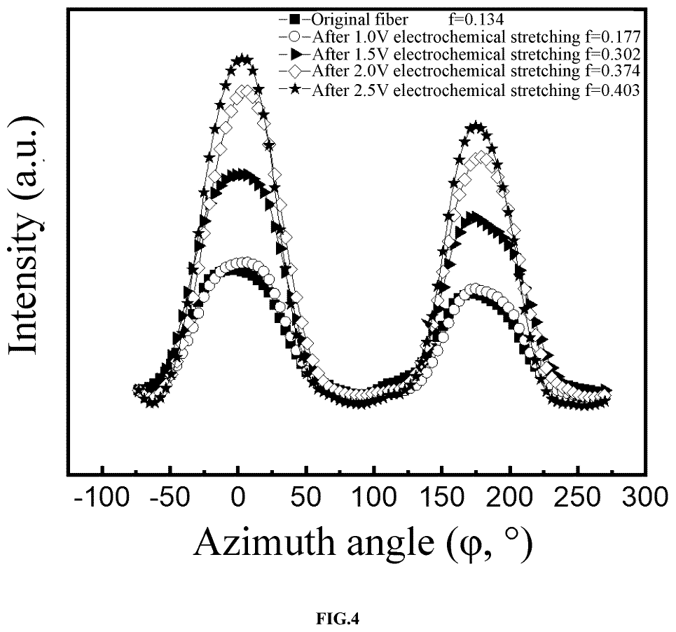

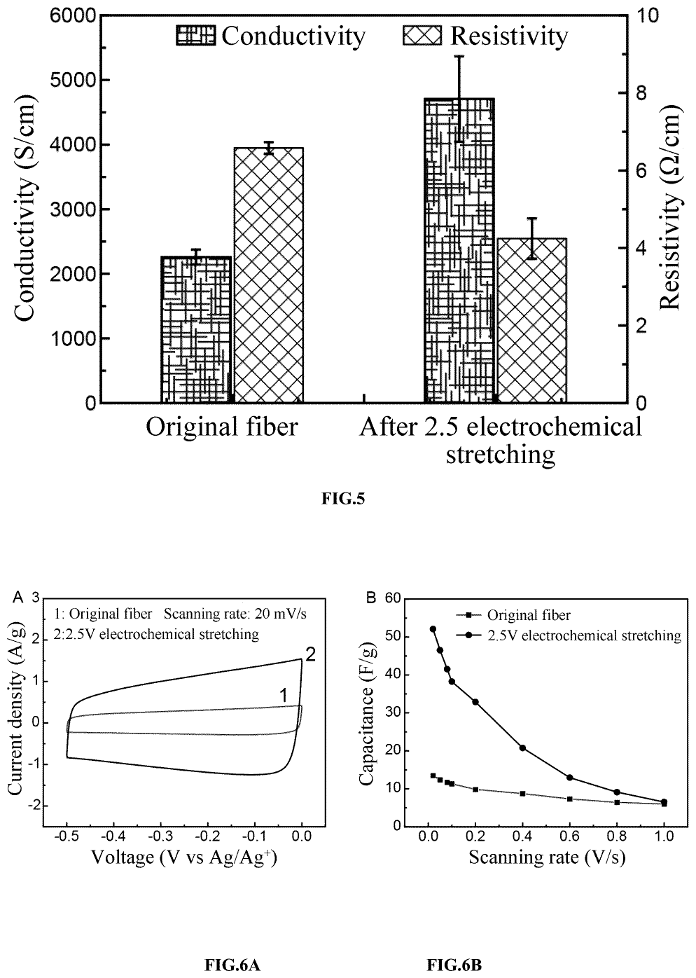

An electrochemical stretching device was assembled and a three-electrode system was used. A CNT fiber prepared by using a floating vapor deposition method was used as a raw material, the CNT fiber was excessively twisted until a CNT fiber having a certain helical structure was formed, the above CNT fiber prepared was used as a working electrode; a counter electrode was used as a platinum black electrode; a reference electrode was an Ag/Ag electrode. The electrolyte adopted 0.5 mol/L 1-ethyl-3-methylimidazole tetrafluoroborate/propylene carbonate. A stretch stress of 6.33 MPa was applied, a voltage was applied by using an electrochemical workstation, and specific parameters were as follows: low voltage: −1 V; frequency: 0.1 Hz; cycle: 10 circles. Different stretch ratios were obtained by applying different high voltages (1 V-2.5 V), as shown in FIG. 3, the fibers drawn at different positive voltages were subjected to WAXS characterization (the internal orientation of the fiber can be determined through WAXS characterization, wherein f was an orientation factor with a value of 0-1, the closer f was to 1, the better the orientation was), as shown in FIG. 4. The experimental results show that the higher the voltage, the larger the stretch ratio, the better the internal orientation of the CNT fiber. Conductivity, resistivity and capacitance tests were performed on the original CNT fiber and the fiber after electrochemical stretching with a voltage of 2.5 V, as shown in FIG. 5 and FIG. 6A-FIG. 6B, and the conductivity and capacitance were all greatly improved after electrochemical stretching.

### Example 2

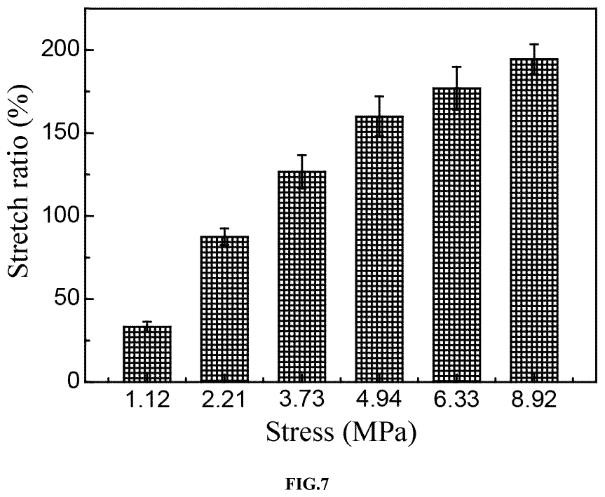

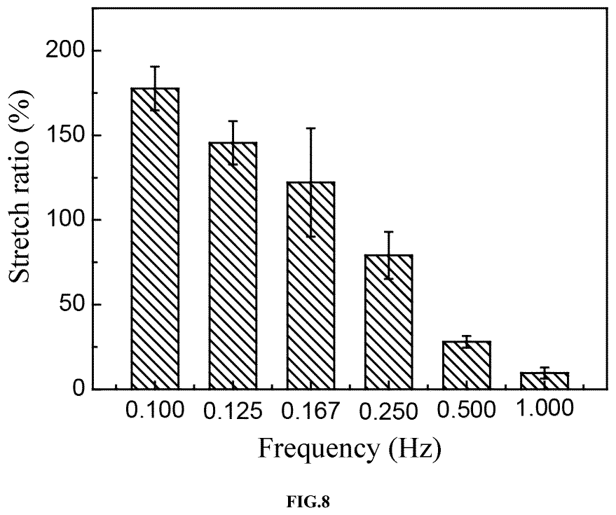

An electrochemical stretching device was assembled and a three-electrode system was used. A CNT fiber prepared by using a floating vapor deposition method was used as a raw material, the CNT fiber was excessively twisted until a CNT fiber having a certain helical structure was formed, the above CNT fiber prepared was used as a working electrode; a counter electrode was used as a platinum black electrode; a reference electrode was an Ag/Ag+ electrode. The electrolyte adopted 0.5 mol/L 1-ethyl-3-methylimidazole tetrafluoroborate/propylene carbonate. A voltage was applied by using an electrochemical workstation, and specific parameters were as follows: low voltage: −1 V; high-low voltage: 2.5V; frequency: 0.1 Hz; cycle: 10 circles. Different stretch ratios were obtained by applying different high voltages, as shown in FIG. 7.

### Example 3

An electrochemical stretching device was assembled and a three-electrode system was used. A CNT fiber prepared by using a floating vapor deposition method was used as a raw material, the CNT fiber was excessively twisted until a CNT fiber having a certain helical structure was formed, the above CNT fiber prepared was used as a working electrode; a counter electrode was used as a platinum black electrode; a reference electrode was an Ag/Ag+electrode. The electrolyte adopted 0.5 mol/L 1-ethyl-3-methylimidazole tetrafluoroborate/propylene carbonate. A stretch stress of 6.33 MPa was applied, a voltage was applied by using an electrochemical workstation, and specific parameters were as follows: low voltage: −1 V; high-low voltage: 2.5V; frequency: 0.1 Hz; cycle: 10 circles. Different stretch ratios were obtained by applying different frequencies of voltages (0.1 Hz-1 Hz), as shown in FIG. 8.

Further, the inventor of this case tested a frequency of 2 Hz. The results are similar to those in FIG. 8.

### Example 4

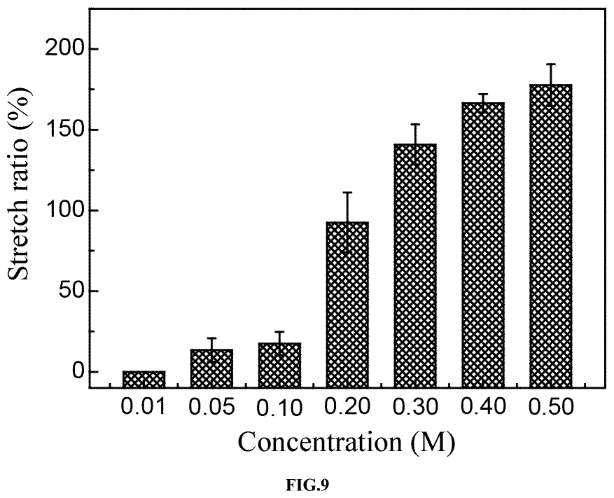

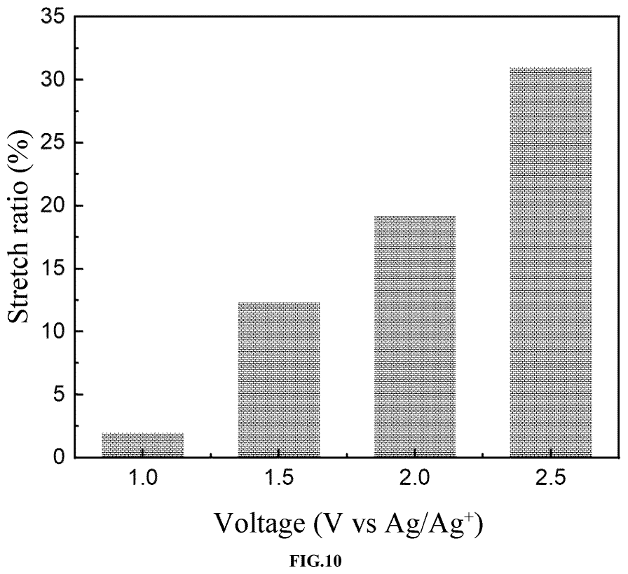

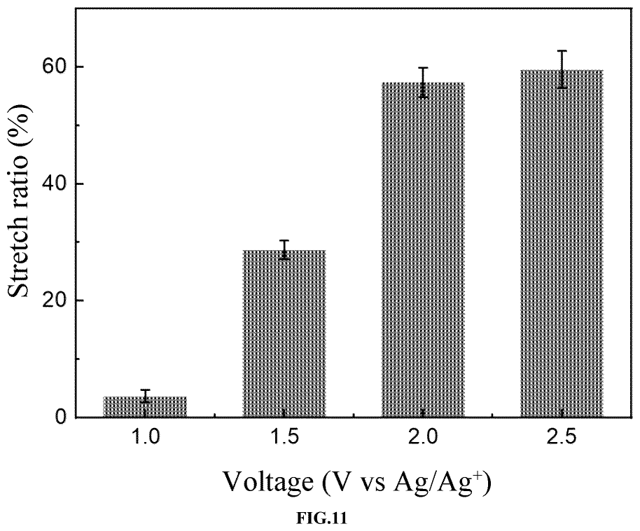

An electrochemical stretching device was assembled and a three-electrode system was used. A CNT fiber prepared by using a floating vapor deposition method was used as a raw material, the CNT fiber was excessively twisted until a CNT fiber having a certain helical structure was formed, the above CNT fiber prepared was used as a working electrode; a counter electrode was used as a platinum black electrode; a reference electrode was an Ag/Ag+ electrode. A stretch stress of 6.33 MPa was applied, a voltage was applied by using an electrochemical workstation, and specific parameters were as follows: low voltage: −1 V; high-low voltage: 2.5 V; frequency: 0.1 Hz; cycle: 10 circles. Different stretch ratios were obtained by applying different concentrations of 1-ethyl-3-methylimidazole tetrafluoroborate/propylene carbonate electrolytes, as shown in FIG. 9.

Further, the inventor of this case tested a 1-ethyl-3-methylimidazole tetrafluoroborate/propylene carbonate electrolyte with a concentration of 1 mol/L. The results are similar to those in FIG. 9.

### Example 5

An electrochemical stretching device was assembled and a three-electrode system was used. A CNT fiber prepared by using a floating vapor deposition method was used as a raw material, and an untwisted CNT fiber was used as a working electrode; a counter electrode was a platinum black electrode; a reference electrode was an Ag/Ag+ electrode. The electrolyte adopted 0.5 mol/L 1-ethyl-3-methylimidazole tetrafluoroborate/propylene carbonate. A stretch stress of 6.33 MPa was applied, a voltage was applied by using an electrochemical workstation, and specific parameters were as follows: low voltage: −1 V; frequency: 0.1 Hz; cycle: 10 circles. Different stretch ratios were obtained by applying different high voltages (1 V-2.5 V), as shown in FIG. 10.

Further, the inventor of this case tested a high voltage of 10 V. The results are similar to those in FIG. 10.

### Example 6

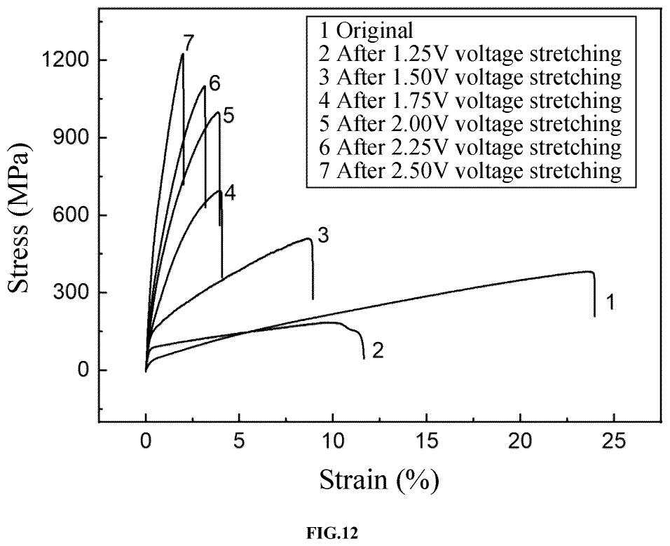

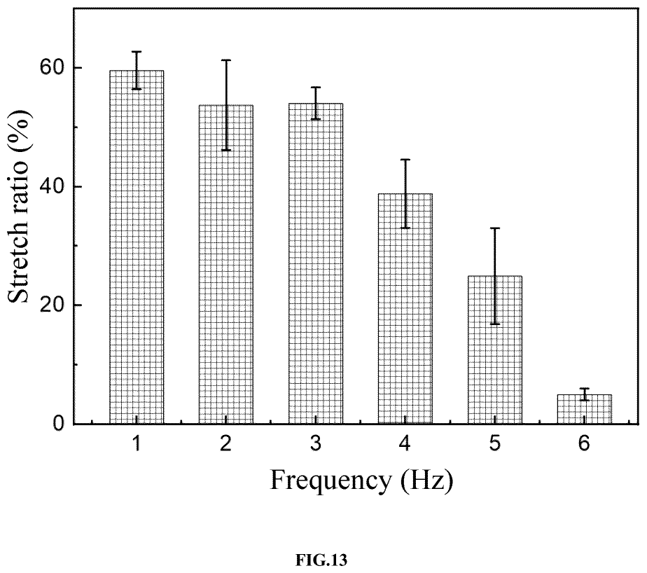

An electrochemical stretching device was assembled and a three-electrode system was used. A CNT fiber prepared by using a floating vapor deposition method was used as a raw material, and a twisted CNT fiber (helical fibers were not formed) was used as a working electrode; a counter electrode was a platinum black electrode; a reference electrode was an Ag/Ag+ electrode. The electrolyte adopted 0.5 mol/L 1-ethyl-3-methylimidazole tetrafluoroborate/propylene carbonate. A stretch stress of 6.33 MPa was applied, a voltage was applied by using an electrochemical workstation, and specific parameters were as follows: low voltage: −1 V; frequency: 0.1 Hz; cycle: 10 circles. Different stretch ratios were obtained by applying different high voltages (1 V-2.5 V), as shown in FIG. 11. Mechanical testing was performed on the twisted fiber after electrochemical stretching at different voltages, as shown in FIG. 12. After electrochemical stretching, the mechanical strength was significantly increased due to significantly increased orientation.

### Example 7

An electrochemical stretching device was assembled and a three-electrode system was used. A CNT fiber prepared by using a floating vapor deposition method was used as a raw material, and a twisted CNT fiber (a helical fiber was not formed) was used as a working electrode; a counter electrode was a platinum black electrode; a reference electrode was an Ag/Ag+ electrode. The electrolyte adopted 0.5 mol/L 1-ethyl-3-methylimidazole tetrafluoroborate/propylene carbonate. A stretch stress of 6.33 MPa was applied, a voltage was applied by using an electrochemical workstation, and specific parameters were as follows: low voltage: −1 V; high-low voltage: 2.5 V; frequency: 0.1 Hz; cycle: 10 circles. Different stretch ratios were obtained by applying different frequencies (0.1 Hz-1 Hz) of voltages, as shown in FIG. 13.

### Example 8

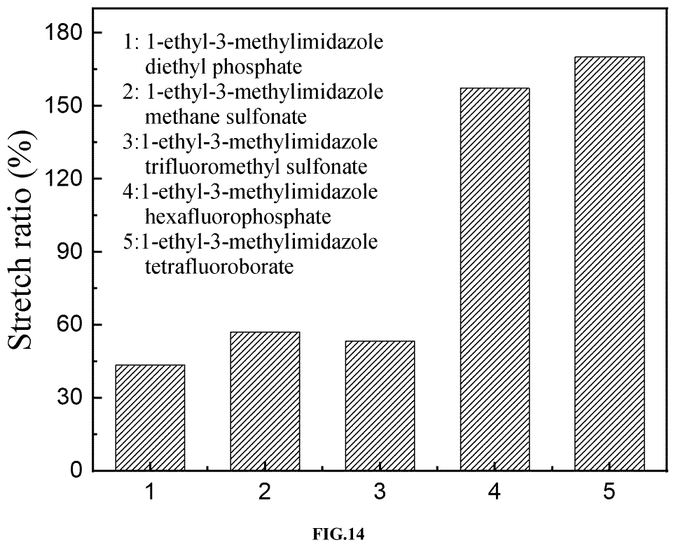

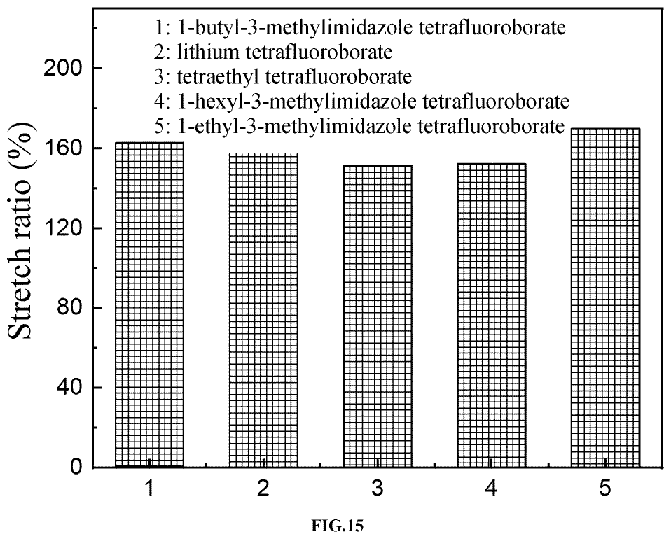

An electrochemical stretching device was assembled and a three-electrode system was used. A CNT fiber prepared by using a floating vapor deposition method was used as a raw material, the CNT fiber was excessively twisted until a CNT fiber having a certain helical structure was formed, the above CNT fiber prepared was used as a working electrode; a counter electrode was used as a platinum black electrode; a reference electrode was an Ag/Ag+ electrode. A stretch stress of 6.33 MPa was applied, a voltage was applied by using an electrochemical workstation, and specific parameters were as follows: low voltage: −1 V; high-low voltage: 2.5V; frequency: 0.1 Hz; cycle: 10 circles; the electrolytes were 0.5 mol/L different electrolytes, wherein solvents were propylene carbonate, and solutes included identical cations and different anions; specifically, as follows: 1-ethyl-3-methylimidazole diethyl phosphate; 1-ethyl-3-methylimidazole methane sulfonate; 1-ethyl-3-methylimidazole trifluoromethanesulfonate; 1-ethyl-3-methylimidazole hexafluorophosphate; 1-ethyl-3-methylimidazole tetrafluoroborate. The stretch ratios of different electrolytes are shown in FIG. 14.

### Example 9

An electrochemical stretching device was assembled and a three-electrode system was used. A CNT fiber prepared by using a floating vapor deposition method was used as a raw material, the CNT fiber was excessively twisted until a CNT fiber having a certain helical structure was formed, the above CNT fiber prepared was used as a working electrode; a counter electrode was used as a platinum black electrode; a reference electrode was an Ag/Ag+ electrode. A stretch stress of 6.33 MPa was applied, a voltage was applied by using an electrochemical workstation, and specific parameters were as follows: low voltage: −1 V; high-low voltage: 2.5 V; frequency: 0.1 Hz; cycle: 10 circles; the electrolytes were 0.5 mol/L different electrolytes, wherein solvents were propylene carbonate, solutes included identical cations and different anions; specifically, as follows: 1-butyl-3-methylimidazole tetrafluoroborate; lithium tetrafluoroborate; tetraethyl tetrafluoroborate; 1-hexyl-3-methylimidazole tetrafluoroborate; 1-ethyl-3-methylimidazole tetrafluoroborate. The stretch ratios of different electrolytes are shown in FIG. 15.

In addition, the inventor of this case performed a test by referring to the aforementioned embodiments and using other raw materials, process operations and process conditions mentioned in this description, and obtained ideal results.

The various aspects, embodiments, features, and examples of this application shall be deemed explanatory in all respects and are not intended to limit this application. The scope of this application is only defined by the claims. Without departing from the spirit and scope of the claimed application, those skilled in the art will be aware of other embodiments, modifications, and uses.

Although the present application has been described with reference to illustrative embodiments, those skilled in the art will understand that various other changes, omissions, and/or additions may be made without departing from the spirit and scope of the present application, and substantial equivalents may be used to replace the components of the embodiments. In addition, many modifications can be made without departing from the scope of the present application to adapt specific situations or materials to the teachings of the present application. Therefore, this patent is not intended to limit the present application to the specific embodiments disclosed for executing the present application, but rather to include all embodiments within the scope of the attached claims. Furthermore, unless specifically stated, any use of terms first, second, etc. does not indicate any order or importance, but rather uses terms first, second, etc. to distinguish one element from another.

What is claimed is:

1. A method for preparing an aligned carbon nanotube (CNT) fiber through electrochemical stretching, comprising:
constructing an electrochemical reaction system by at least using an original CNT fiber as a working electrode, a counter electrode, a reference electrode and an electrolyte, wherein the electrolyte is an organic system, cations contained in the electrolyte are derived from a tetraethyl salt, a tetrabutyl salt or a tetrahexyl salt, and anions contained in the electrolyte are derived from salts comprising at least one of tetrafluoroborate, hexafluorophosphate, and/or ionic liquids;
applying a selected stretch stress to the original CNT fiber while powering on the electrochemical reaction system so that ions in the electrolyte are embedded into the original CNT fiber, and an orientation of the carbon nanotube is generated due to the action of the stretch stress under the state of expansion; and
powering off the electrochemical reaction system while maintaining the application of the selected stretch stress, so that the ions in the electrolyte are released, thereby obtaining a highly aligned CNT fiber.

2. The method according to claim 1, wherein the electrolyte also comprises an organic solvent.

3. The method according to claim 2, wherein the organic solvent comprises propylene carbonate.

4. The method according to claim 3, wherein the electrolyte comprises 1-ethyl-3-methylimidazole tetrafluoroborate/propylene carbonate.

5. The method according to claim 1, wherein a concentration of the electrolyte in the electrolyte is 0.01 mol/L or more, preferably 0.1-1 mol/L.

6. The method according to claim 1, wherein the selected stretch stress applied to the original CNT fiber is 1 MPa or more.

7. The method according to claim 6, wherein the selected stretch stress applied to the original CNT fiber is 1-9 MPa.

8. The method according to claim 1, wherein a voltage applied to the original CNT fiber is 0-10 V, and an applying frequency of the voltage is 0.01-2 Hz.

9. The method according to claim 1, wherein a stretch ratio of the electrochemical stretching is 10%-180%.

10. The method according to claim 1, wherein the original CNT fiber is a CNT fiber prepared by using a floating catalyst method.

11. The method according to claim 10, wherein the original CNT fiber comprises at least one of an untwisted CNT fiber, a twisted CNT fiber, and an excessively twisted helical CNT fiber.

12. The method according to claim 1, wherein the reference electrode is an Ag/Ag⁺ electrode; and/or the counter electrode is a platinum black electrode.

13. A highly aligned CNT fiber prepared by using the method according to claim 1.

14. A device for preparing an oriented CNT fiber through electrochemical stretching, applied in the method according to claim 1, comprising:
the electrochemical reaction system at least comprising the original CNT fiber as the working electrode, the counter electrode, the reference electrode and the electrolyte; and
an electrochemical stretching mechanism at least used for applying the selected stretch stress to the original CNT fiber for electrical stretching treatment.

15. A highly aligned CNT fiber prepared by using the method according to claim 2.

16. A highly aligned CNT fiber prepared by using the method according to claim 3.

17. A highly aligned CNT fiber prepared by using the method according to claim 4.

18. A highly aligned CNT fiber prepared by using the method according to claim 5.

19. A highly aligned CNT fiber prepared by using the method according to claim 6.

20. A highly aligned CNT fiber prepared by using the method according to claim 7.
